(19) United States
(12) Patent Application Publication
(10) Pub. No.: US 2010/0170195 A1
(43) Pub. Date: Jul. 8, 2010

(54) Mailpiece and method of authentification of mailing

(76) Inventor: David Levi Gwaltney, Las Cruces, NM (US)

Correspondence Address: RAFATY LAW GROUP, PLLC, 18926 CAMPBELL ROAD, DALLAS, TX, 75252, US

(21) Appl. No.: 12/319,336

(22) Filed: Jan. 6, 2009

(51) Int. Cl. B65B 61/20; B65D 27/04; B42D 15/00

(52) U.S. Cl. 53/284.3; 229/71; 283/74

(57) ABSTRACT

An improved mailpiece for efficient capture of postage cancellation indicia on the envelope and the document inside of the envelope, the envelope comprising an upper edge, a bottom edge, a left edge and a right edge, an open air window substantially near the upper edge of the envelope and away from the right edge of the envelope for receiving a first postage cancellation indicia on the envelope to the right of the window, the document comprising a document clear zone space on a face of the document for receiving a second postage cancellation indicia, the document clear zone space visible through the window when the document is inserted inside of the envelope.

### BACKGROUND

The disclosure is directed to an improved mailpiece comprising an envelope and a document inside of the envelope adapted for the simultaneous and efficient capture of postage cancellation indicia on the envelope and application of a postage cancellation indicia directly on the document.

### SUMMARY OF THE INVENTION

According to the 2007 Comprehensive Statement on Postal Operations, almost 100 billion pieces of First Class mail were handled by the United States Postal Service. Traditional means (whether via metered postage imprint or stick-on stamp) for affixing postage indicia to an envelope of a mailpiece remain in widespread use today. Once affixed, the postage is cancelled via mailpiece handling operations of the U.S. Postal Service (or, in the case of metered postage indicia, automatically cancelled upon affixing of the metered postage indicia). Cancelled postage indicia, which typically include but are not limited to a postmark generated by the U.S. Postal Service, contain important mailing record information relating to the document sent with the mailpiece. Unless the envelope with the cancelled postmark is retained by the recipient of the mailpiece, direct evidence of the sender's date of deposit of the mailpiece with the post office is lost, that is unless the sender purchases postage services (e.g., Express Mail, Certified Mail) for a fee and retains documentation of such purchase. The applicant has invented an improved mailpiece that is USPS compliant, readily integrated with current systems for affixing postage to mailpieces, and a mailpiece which overcomes problems in the prior art by allowing for the simultaneous and efficient ‘spoiling’ or cancellation of the envelope and the contents

The USPS, per Publication 32, defines mailpiece as “a single addressed article of mail, usually a letter, flat, card or parcel.” The term ‘mailpiece’ as used herein shall refer to a single article of mail comprising in combination an envelope and its contents. The term ‘contents’ is intended to be broadly construed to include any document including but not limited to for example a check, invoice, receipt, money order, tax return, travel ticket, concert ticket, offer (e.g. to enter into a purchase contract), invoice, service cancellation or interruption notice, executed (signed) contract, request for documentation, an immigration document, appointment reminder notice, certificate of completion of a program of study, a bill of sale, contest entry or any other document serving a different purpose. The term ‘contents’ and ‘document’ are used interchangeably herein. The term ‘envelope’ as used herein refers broadly to a covering used to contain and transmit a document via the postal system. For USPS guidelines, the applicant has consulted references such as the Mailpiece QC Program, Self-Study Guide Modules September 2007 and U.S. Postal Service Domestic Mail Manual (DMM), pe.usps.gov/text/dmm300/dmm300_landing.htm.

Open air windows in envelopes are known. An open air window on an envelope for exposing sendee and/or sendee information printed on contents inserted inside of the envelope are known. Also known is an open air window on an envelope for exposing postage indicia/mailing record affixed to contents inserted inside of the envelope. Additionally, there are prior art systems which teach ways to affix mailing record information unto a document.

U.S. Pat. No. 1,988,908 to MacKinnon discloses a covering having a separable portion integral with the covering for receiving a mailing record and teaches affixing of the separable portion onto the letter or document mailed with the covering. MacKinnon uses the term ‘covering’ to include ‘envelope.’

U.S. Pat. No. 6,029,883 to Hechinger et al. is directed to an envelope package comprising a window with a substantially transparent covering having apertures such that when a piece having pre-printed postage indicia is inserted inside of the envelope package with pre-printed postage indicia visible through the window, the document will have portions of postage cancellation indicia directly on the document.

U.S. Pat. No. 7,343,357 to Kara is directed to a system for printing postage and discloses a feature whereby a postage indicia may be printed directly onto a document such that said postage indicia are visible through a disclosed window of an envelope containing the document.

U.S. Pat. No. 3,937,492 to Biron discloses an embodiment for a mailing instrument comprising an integral body formed of a sheet including an envelope portion, a cover portion and a sealing flap portion and teaches placement of a postage stamp directly on the cover portion of the mailing instrument such that cancellation of the postage stamp thereon is applied directly to the mailing instrument.

The applicant is not aware of prior art systems which are directed to an improvement for ‘traditional’ (meaning two-piece, envelope plus its contents) mailpieces providing for the efficient simultaneous ‘cancellation’ or spoliation of the postage indicia on the envelope and capture of a postage cancellation indicia directly on the contents of the envelope of the mailpiece. The applicant's invention thus addresses a known problem with prior art envelopes having an open air window in the area traditionally intended for placement of postage indicia, namely the possibility for fraudulent and undesired re-use of such envelopes. The applicant's invention also addresses the problem of the need for an oversized open air window (to accommodate the entire postmark) thus making the contents of the mailpiece susceptible to tampering or damage in handling.

The applicant has invented an improved mailpiece, compliant with mailpiece design guidelines as set forth by the USPS, where the postage cancellation step for the mailpiece spoils or cancels the postage indicia on the envelope and simultaneously provides a postage cancellation indicia directly on the document inserted inside of the envelope. In accordance with the invention, an envelope is provided with an open air window positioned near the top edge of the envelope and sufficiently away from the right edge of the envelope to allow for the placement of postage indicia (whether lick-on stamp or metered postage stamp using a postage metering machine) directly on the envelope (and to the right of the disclosed window) in the traditional area where postage is affixed to the envelope. Per an embodiment of the disclosed mailpiece where a postage stamp is manually affixed to the envelope, the document inside of the envelope of the improved mailpiece comprises a so-called ‘clear zone,’ a space devoid of markings which receives a part of the postage cancellation indicia (e.g., the circular postmark) directly on the document when the document is properly inserted inside of the envelope with the clear zone visible through the window. Thus, the document standing alone and separated from its mailing envelope, includes direct evidence of the date of mailing of the check. This is valuable information, readily and inexpensively captured. that can help reduce potential disputes with credit card companies and other creditors of the sender. It is cumbersome and inefficient to save, upon receipt, the entire mailpiece, namely the envelope and its contents, as a record of the date of posting of the mailpiece.

The disclosed invention applies to situations where the sender manually affixes a postage stamp to the envelope of the mailpiece and situations where the sender meters postage onto the envelope of the mailpiece using a postage metering apparatus that is specifically modified to provide an imprint, a so-called Dual-Date Postage Indicia, as disclosed herein.

Once separated from its envelope, the contents of the disclosed mailpiece comprise a postage cancellation indicia imprinted directly on the contents (in the area herein called the Document Clear Zone per below) and standing alone, without the envelope (which may be discarded at will), the contents contain proof of the date of mailing of the contents. Thus, per the disclosed invention, the document of the mailpiece is modified to provide on the document a USPS color compliant clear space, namely a Document Clear Zone that is free of print or marking and is sufficient in size to receive a postage cancellation indicia or portion thereof directly on the document. The Document Clear Zone is positioned on the document in such a way to ensure that the Document Clear Zone is exposed through the window of the envelope when the document is inserted into the envelope of the disclosed mailpiece.

The disclosed mailpiece comprises an envelope which has an open air window specially located to be offset from the right edge of the envelope (and near the upper edge of the envelope) expressly to allow for placement of postage indicia directly onto the envelope in the area (could be referred to as the Envelope Indicia Clear Space) traditionally designated for placement of postage indicia on the envelope. To be USPS compliant, for courtesy reply envelopes, the leftmost edge of the disclosed window does not extend past 1¾″ from the right edge of the envelope so as not to encroach on the Facing Identification mark (FIM) Clear Zone as per USPS Guidelines. For standard letter envelopes, USPS compliance requires that the leftmost edge of the disclosed window may not extend past 50% of the horizontal length of the envelope measured from the right edge of the envelope. Also, the uppermost edge of the open air window is no more than ¼″ from the top of the envelope as per USPS guidelines for the window. The bottom edge of the disclosed window does not extend past 2¾″ measured from the bottom of the envelope so as to not encroach on the OCR Read Area as per USPS guidelines.

Per a preferred embodiment for the disclosed open air window, the open air window is circular in shape so as to minimize the size of the window while still enabling direct application of all or part of postage cancellation indicia onto the so-called Document Clear Zone of the contents. The circular shape also minimizes potential ‘bow points’ whereby the window could be tampered with to view non-exposed portions of the contents of the envelope. Thus, the circular open air window helps to minimize risk of tampering of the mailpiece and/or damage to its contents. The circular shape is also consistent with the current customary postage cancellation stamp used by the U.S. Postal Service (and also used in metered postage) which comprises a circular portion typically containing the place of origin and date of posting. Of course, alternative shapes for the open air window are possible and include an ellipse, square, rectangle, or other shape limited only by the imagination of the designer.

It is noted that a postage cancellation is sometimes deemed effective at the time that the user meters the mailpiece with postage indicia using a postage metering machine and deposits the mailpiece in a mailbox. In that instance, affixing the metered postage indicia is equal to affixing the postage cancellation indicia. Thus, per one method of exercising the disclosed invention, the sender of the disclosed improved mailpiece inserts a document into the envelope of the mailpiece such that the Document Clear Zone corresponds with the open air window of the envelope, seals the envelope and then runs the mailpiece through a postage meter adapted to imprint simultaneously (e.g., in a single-pass of the assembled mailpiece through the meter) a first postage (cancellation) indicia on the envelope and a second postage (cancellation) indicia in the open air window and directly on the document inside of the envelope.

Per another feature of the disclosed invention, an improved envelope is provided wherein the disclosed open air window portion of the envelope is covered with a removable cover, whereby the user may remove (e.g., peel off) the cover to allow for the above-described postage metering step, then manually re-attach the cover to the window portion of the envelope before depositing the mailpiece in a mailbox. The purpose of the cover is to protect the contents of the mailpiece from damage during handling. The cover may be either opaque or transparent. Per a preferred embodiment, the disclosed cover includes an adhesive coating on the portion of the cover that contacts the envelope for secure re-attachment of the cover to the envelope while ensuring there is no adhesive directly in the open air portion which could come into contact with the contents of the envelope.

The disclosed invention is also directed to a system for the printing of postage indicia on the disclosed mailpiece which system comprises a computer readable program on a computer-readable medium comprising instructions for generating an imprint, a so-called Dual-Date Postage Indicia, comprising a first postage indicia and a second postage indicia located to the left of the first postage indicia, where the first postage indicia portion of the imprint prints directly onto the envelope (in the upper right hand corner of the envelope in the Envelope Indicia Clear Space traditionally designated for postage indicia) and the second postage indicia portion prints directly onto the Document Clear Zone portion of the contents of the envelope through the disclosed window in the envelope and where the first postage indicia and the second postage indicia each contain date of posting information. The Dual-Date Postage Indicia imprint may be generated by a postage machine such as the highly modifiable DM Series Pitney Bowes. A user may use such a modified machine to simultaneously print the mailpiece, i.e., the envelope and its contents (through the window of the envelope), with the Dual-Date Postage Indicia.

Per another optional feature, a circular band or other imprint may be incorporated into the postage cancellation or meter stamp to allow for the ready detection of the proper re-use of an envelope.

Per another optional feature, the disclosed envelope with the open air window comprises a thin band of a semi-adhesive material applied to the inside of the envelope in the area of the border of the open air window such that when a document is inserted inside of the envelope, a light, releasable seal is created around the Document Clear Zone exposed through the window. This feature helps to minimize exposure to the elements of the non-Document Clear Zone portion of the document.

Per an alternative embodiment, the envelope of the disclosed mailpiece system may be provided with means for user, at will, to ‘expose’ the open air window of the envelope. Per such alternative embodiment for the envelope of the mailpiece, the envelope may have perforation or other means enabling tear-away exposure of the open air window. Thus, at the user's discretion, the envelope per this alternative embodiment may be used in the traditional way or the novel way as disclosed herein.

### BRIEF DESCRIPTION OF THE DRAWINGS

FIG. 1 is an exploded view of an embodiment of the disclosed mailpiece where the mailpiece is metered.

FIG. 2 shows a preferred embodiment for the disclosed mailpiece comprising a check.

FIG. 3 shows an exemplary embodiment for an imprint for a Dual-Date Postage Indicia as per the disclosed invention.

FIG. 4 shows a check with a postage cancellation indicia imprint per the disclosed invention.

FIG. 5 shows an exemplary embodiment for an envelope with an open air window and optional removable window covering.

### DESCRIPTION OF THE DRAWINGS

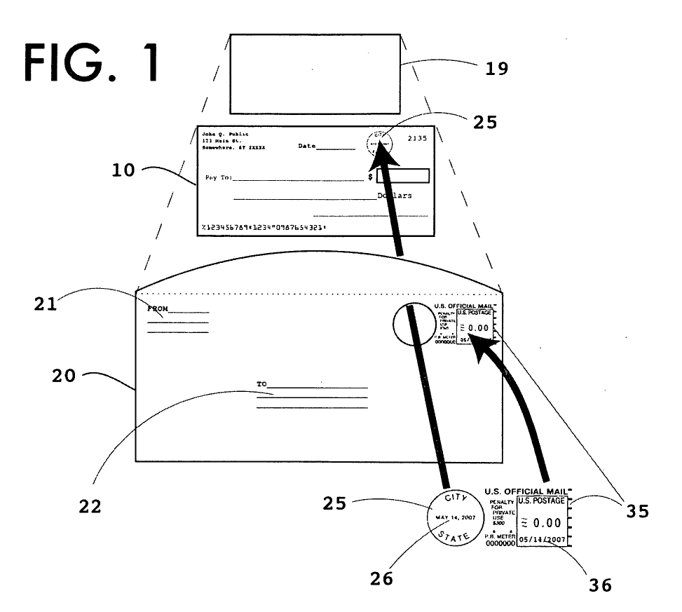

FIG. 1 shows an exploded view for an embodiment of the disclosed mailpiece where the contents is a check and where metered postage indicia are used. Per FIG. 1, the mailpiece comprises a standard letter envelope 20 and check 10 which is inserted inside of the envelope 20 to comprise the mailpiece. The envelope includes a front face having a portion 21 for sender information, a portion 22 for sendee information, an open air window 25 and a metered postage indicia 35 to the right of the open air window 25, the postage indicia 35 comprising a date of mailing indicia 36. The check 10 is shown with a postage indicia portion 25 comprising a date of mailing indicia 26 printed on the check in the Document Clear Zone 15 of the check 10. The envelope comprises a back panel 19 which is shown to point out that the check 10 is inserted inside of the envelope 20 between the front face of the envelope and the back panel 19 of the envelope 10.

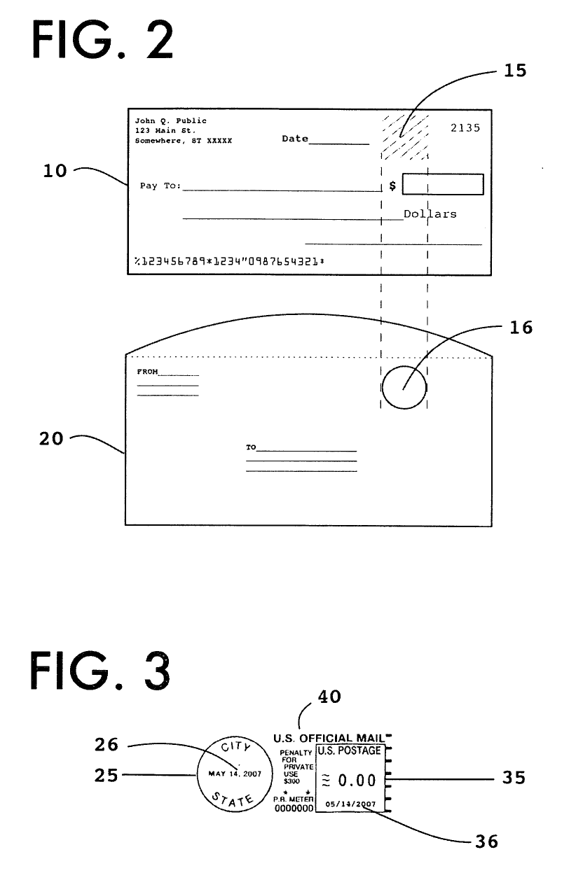

FIG. 2 shows a preferred embodiment for the disclosed mailpiece comprising a check. Per FIG. 2, there is provided an envelope 20 comprising a circular open air window 16 offset from the right edge of the envelope to allow for placement therein of a postage indicia, a check 10 comprising a Document Clear Zone 15 on the check 20 positioned so to be visible through the open air window 16 of the envelope 20 when the check 10 is inserted inside of the envelope 20 for mailing.

FIG. 3 shows an exemplary embodiment for an imprint for a Dual-Date Postage Indicia as per the disclosed invention when postage is affixed to the mailpiece via a postage metering apparatus modified to practice the disclosed method. Per FIG. 3, the imprint comprises a First Postage Cancellation Indicia 40 to the right of a so-called Second Postage Cancellation Indicia 25. The First Postage Cancellation Indicia comprises a post date 36 and the Second Postage Cancellation Indicia comprises a post date 26. Note that the two post dates are the same date because per the disclosed mailpiece postage cancellation method using a postage metering machine, there is simultaneously affixed a postage (cancellation) indicia on the check and a postage (cancellation) indicia on the envelope.

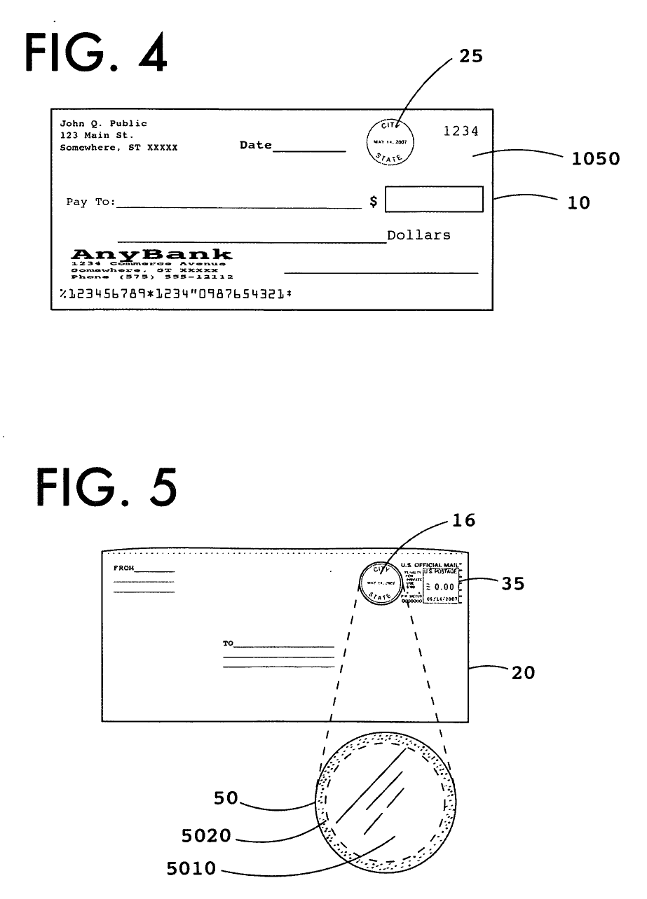

FIG. 4 shows a check 10 with an exemplary Second Postage Cancellation Indicia 25 imprinted on the check 10 to the left of the Check Number Portion 1050 of the check. and in the area that is the Document Clear Zone portion of the check. Please note that, while this is not shown, typically the Payee Name, Payor Signature and Amount are filled in on the check before the check is mailed per the disclosed mailpiece.

FIG. 5 shows an exemplary embodiment for an envelope with an open air window and optional removable window covering. The open air window 16 of the disclosed envelope 20 is covered with a removable, re-attachable covering 50 which includes an adhesive band 5020 on its back face and is composed of a transparent material 5010.

1. A mailpiece comprising in combination an envelope and a document inside of the envelope,
the envelope comprising an upper edge, a bottom edge, a left edge and a right edge, an open air window substantially near the upper edge of the envelope and away from the right edge of the envelope for receiving a first postage cancellation indicia on the envelope to the right of the window,
the document comprising a document clear zone space on a face of the document for receiving a second postage cancellation indicia, the document clear zone space visible through the window when the document is inserted inside of the envelope.

2. The mailpiece per claim 1 wherein the document comprises a time-sensitive written response to a communication requiring a response by a designated deadline date.

3. The mailpiece per claim wherein the document is one of a check, money order, tax return, and invoice.

4. The mailpiece per claim 1 wherein the document is one of an insurance policy and a completed insurance claim form.

5. The mailpiece per claim 1 wherein the document is an offer.

6. The mailpiece per claim 1 wherein the document comprises a response to a request for documentation.

7. The mailpiece per claim 1 where the document is an original executed contract.

8. The mailpiece per claim 1 wherein the document is one of a service interruption notice and a service cancellation notice by a service provider.

9. A document comprising a document clear zone space portion on a face of the document, the document clear zone space portion dedicated to receiving a postage cancellation indicia, the document clear zone space portion located on the document so to be visible through an open air window of an envelope containing the document.

10. The document per claim 9 further comprising a postage cancellation indicia in the document clear zone space portion of a face of the document.

11. The document per claim 9 wherein the document is one of a check, money order, invoice and service cancellation notice.

12. The mailpiece per claim 1 wherein the window is substantially circular in shape.

13. The mailpiece per claim 1 wherein the window is substantially elliptical in shape.

14. The mailpiece per claim 1 wherein the mailpiece further comprises a first postage cancellation indicia on the envelope and a second postage cancellation indicia imprinted on the document and visible through the window, the first postage cancellation indicia and the second postage cancellation indicia comprising a duplicate date of posting information.

15. The mailpiece per claim 1 wherein the document is a letter of acceptance of funds in a 10-35 exchange as defined by the Internal Revenue Service.

16. the mailpiece per claim 1 wherein the document is a request to exercise policy surrender under the auspices of the free look period as prescribed by insurance law.

17. An envelope comprising an upper edge, a bottom edge, a left edge and a right edge, an open air window substantially near the upper edge of the envelope and away from the right edge of the envelope for allowing placement of a postage cancellation indicia on the envelope to the right of the window, the location of the window being compliant with U.S. Postal Service guidelines relating to a Facing Identification Mark Clear Zone and an Optical Character Recognition Read Area.

18. An envelope comprising an upper edge, a bottom edge, a left edge and a right edge, an open air window portion substantially near the upper edge and away from the right edge for allowing placement of a postage cancellation indicia on the envelope to the right of the window portion, a removable, re-attachable covering for substantially covering the window portion, the window portion situated on the envelope so to be compliant with U.S. Postal Service guidelines relating to a Facing Identification Mark Clear Zone and an Optical Character Recognition Read Area.

19. An envelope composed of folded sheet material comprising an upper edge, a bottom edge, a left edge and right edge, and a window portion substantially near the upper edge and away from the right edge for allowing placement of a first postage cancellation indicia on the envelope to the right of the window portion, the window portion defined by a perforation such that when the sheet material is removed at the perforation an open air window results.

20. The envelope per claim 17 wherein the window portion is one of substantially circular in shape and substantially elliptical in shape.

21. The envelope per claim 17 further comprising a band of adhesive on an inside portion of the envelope at a circumference of the window, the band of adhesive for helping to generate a light seal at the window between a document placed inside of the envelope and the window of the envelope.

22. A method of preparing a mailpiece for mailing comprising the steps of:
Providing an envelope comprising an upper edge, a bottom edge, a left edge and a right edge and an open air window substantially near the upper edge and away from the right edge for receiving a first postage cancellation indicia on the envelope to the right of the window;
Providing a document comprising a document clear zone space for receiving a second postage cancellation indicia in the document clear zone space of the document;
Placing the document inside of the envelope such that the document clear zone space is visible through the window;
Placing a first postage cancellation on the envelope, and
Placing a second postage cancellation indicia on the document in the document clear zone space.

23. A method of preparing a mailpiece for mailing comprising the steps of
Providing a mailpiece comprising a document and an envelope, the envelope comprising an upper edge, a bottom edge, a left edge and a right edge and an open air window substantially near the upper edge and away from the right edge for receiving a first postage cancellation indicia on the envelope to the right of the window, the document comprising a document clear zone space on a face of the document for receiving a second postage cancellation indicia on the document in the document clear zone space,
Inserting the document inside of the envelope such that the document clear zone space is visible through the window and
Simultaneously imprinting the first postage cancellation indicia on the envelope and the second postage cancellation indicia on the document.

24. A postage indicia generated by a postage metering machine comprising a first postage indicia and a second postage indicia, the first postage indicia and the second postage indicia each comprising duplicate date of posting information.
